(19) United States
(12) Patent Application Publication
(10) Pub. No.: US 2007/0115601 A1
(43) Pub. Date: May 24, 2007

(54) Lightning protector for an electrical appliance

(76) Inventor: Lien-Hsun Ho, Taipei (TW)

Correspondence Address: Rabin & Berdo, P.C., Suite 500, 1101 14th Street, Washington, DC, 20005, US

(21) Appl. No.: 11/452,224

(22) Filed: Jun. 14, 2006

(30) Foreign Application Priority Data
Nov. 23, 2005 (TW) 094220288

(51) Int. Cl. H02H 9/06

(52) U.S. Cl. 361/118

(57) ABSTRACT

A lightning protector for a circuit having a load and two inputs includes a protection element adapted to connect to the load in parallel, a point discharging device connected to the protection element in series and having two points spaced apart from each other for a predetermined distance such that when an input voltage is smaller than a critical voltage determined via the predetermined distance between the two points of the point discharging device, the protection element is inactivated and protected.

### BACKGROUND OF THE INVENTION

1. Field of the Invention

The present invention relates to a lightning protector, and more particularly to a lightning protector connected to an electrical appliance in parallel.

2. Description of the Prior Art

According to statistics, most damage to electrical appliances during lightning is a result of wire inducing from the lightning. Therefore, in order to effectively protect the safety of the electrical appliances, it is essential to install a protection element in the wiring system.

The known protection element (10), as shown in FIG. 8, is installed between two inputs L,N of a load (30). When lightning strikes the load (30), the high voltage is input from both inputs L,N. Simultaneously, the protection element (10) is able to direct the high voltage from the lightning away from the load (30) so as to maintain the normal operation of the load (30). The principle of the protection element (10) is to reduce the voltage of the lightning so that no over voltage is passed to the load (30).

Although the protection element (10) provides protection to the load, there is no protection mechanism to the protection element (10). Especially when the protection element (10) is in a situation where the voltage is much higher than normal voltage, e.g. 110V and much lower than the voltage of the lightning, e.g. 6KV, say 220V, the initiation of the protection element (10) provides safety to the load (30), but the protection element (10) may be burned out after a long period of time in a high voltage situation.

To overcome the shortcoming, a temperature sensor is introduced and connected to the protection element (10) in series such that when the temperature of the temperature sensor exceeds its previously designed range, the temperature sensor is burned out and thus protection to the protection element (10) is provided. Conventionally, the temperature protector is a fuse. Therefore, it is quite troublesome for the operator to replace the fuse every time the fuse is burned out.

To overcome the shortcomings, the present invention intends to provide an improved lightning protector to mitigate the aforementioned problems.

### SUMMARY OF THE INVENTION

The primary objective of the present invention is to provide an improved lightning protector to ensure safety of a protection element in abnormal high voltage condition and the load in a lightning strike situation.

In order to accomplish the objective, the lightning protector is a point discharging device connected to the protection element in series so as to provide safety to the protection element. Furthermore, the lightning protector includes a capacitor connected to the protection element in parallel. Still further, the lightning protector includes an inductance connected to the protection element in series.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing the first embodiment of the lightning protector of the present invention;

FIG. 2 is a schematic view showing the second embodiment of the lightning protector of the present invention;

FIG. 3 is a schematic view showing the third embodiment of the lightning protector of the present invention;

FIG. 4 is a schematic view showing the fourth embodiment of the lightning protector of the present invention;

FIG. 5 is a schematic view showing the fifth embodiment of the lightning protector of the present invention;

FIG. 6 is a schematic view showing the sixth embodiment of the lightning protector of the present invention;

FIG. 7 is a schematic view showing the seventh embodiment of the lightning protector of the present invention; and

FIG. 8 is a schematic view showing the conventional lightning protector.

### DETAILED DESCRIPTION OF THE PREFERRED EMBODIMENT

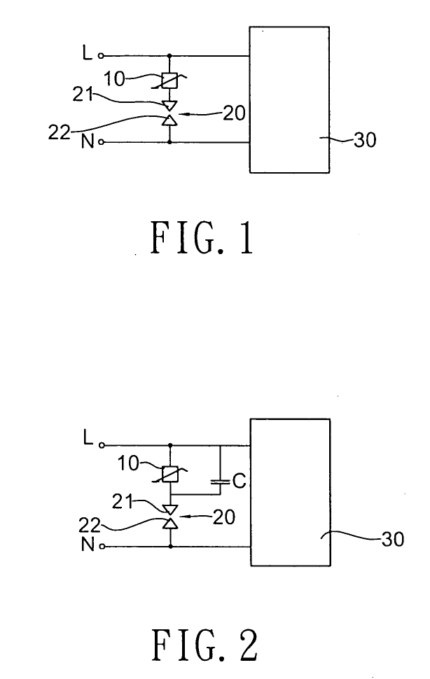

With reference to FIG. 1, it is noted that the lightning protector in accordance with the present invention is applied to a circuit having two inputs (L,N), a load (30) connected respectively to the two inputs (L,N), a protection element (10) connected to the load (30) in series includes a point discharging device (20) connected to the load (30) in parallel and to the protection element (10) in series. The point discharging device (20) has two points (21,22) spaced apart from each other for a predetermined distance. Due to the predetermined distance, a critical voltage is determined in the point discharging device (20).

When the input voltage from both inputs (L,N) exceeds the critical voltage determined via the distance between the two points (21,22), the point discharging device (20) starts point discharge to close the circuit to the protection element (10) such that the protection element (10) is able to direct the voltage away from the load (30). When the input voltage from both inputs (L,N) is smaller than the critical voltage determined via the distance between the two points (21,22) and larger than a predetermined voltage, e.g 110V, there will be no point discharge in the point discharging device (20) and the protection element (10) is not initiated. Thus the protection element (10) is protected.

Further, the distance between the two points (21,22) may be adjusted to change the critical voltage therebetween.

With reference to FIG. 2, the structure of the lightning protector is substantially the same as that shown in FIG. 1. The only difference is that there is a capacitor (C) connected to the protection element (10) in parallel.

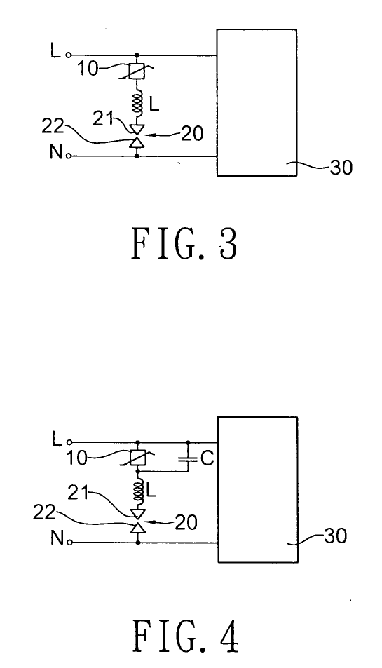

With reference to FIG. 3, the structure of the lightning protector is substantially the same as that shown in FIG. 1. The only difference is that there is a conductance (L) connected to the protection element (10) and the point discharging device (20) in series.

With reference to FIG. 4, it is noted that the protection element (10) is first connected to the capacitor (C) in parallel and then connected to the point discharging device (20) and the conductance (L) in series.

In order to adjust the input voltage to the load (30), as shown in FIG. 5, it is noted that the load (30) is connected to a capacitor (C).

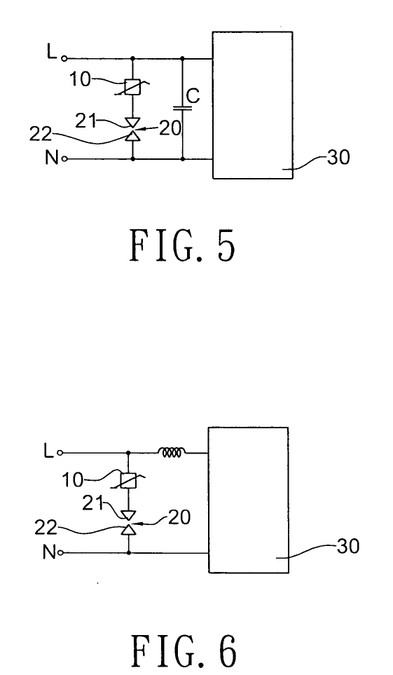

With reference to FIG. 6, the structure of the lightning protector is substantially the same as that shown in FIG. 5. The only difference therebetween is that the conductance (L) is connected to one of the inputs of the load (30) in series.

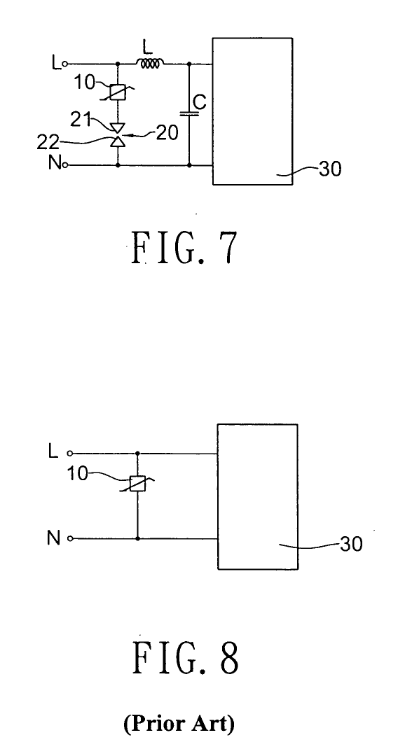

With reference to FIG. 7, it is noted that the capacitor (C) is first connected to the load (30) in parallel and the conductance (L) is then connected to one of the inputs of the load (30) in series.

From the description above, it is noted that when the input voltage is higher than the critical voltage determined between the two points (21,22) of the point discharging device (20), the point discharge of the point discharging device (20) closes the circuit to the protection element (10) to initiate the protection element (10). Thus the load is protected from damage from the lightning. If the input voltage is higher than the previously determined voltage and lower than the critical voltage of the point discharging device (20), there will be no closed circuit and the protection element (10) is protected from damage.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lightning protector for a circuit having a load and two inputs, the lightning protector consisting essentially of:
a protection element adapted to connect to the load in parallel;
a point discharging device connected to the protection element in series and having two points spaced apart from each other for a predetermined distance such that when an input voltage is smaller than a critical voltage determined via the predetermined distance between the two points of the point discharging device, the protection element is inactivated and protected.

2. The lightning protector as claimed in claim 1 further comprising a capacitor connected to the protection element in parallel.

3. The lightning protector as claimed in claim 1, wherein a conductance is connected to the point discharging device and the protection element in series.

4. The lightning protector as claimed in claim 2 further comprising a conductance connected to the point discharging device in series.

5. The lightning protector as claimed in claim 1, wherein a conductance is adapted to connect to one of inputs of the load in series.

6. The lightning protector as claimed in claim 2, wherein a conductance is adapted to connect to one of inputs of the load in series.

7. A lightning protector for a circuit having a load and two inputs, the lightning protector consisting essentially of:
a protection element adapted to connect to the load in parallel;
a capacitor connected to the protection element in parallel; and
a point discharging device connected to the protection element in series and having two points spaced apart from each other for a predetermined distance such that when an input voltage is smaller than a critical voltage determined via the predetermined distance between the two points of the point discharging device, the protection element is inactivated and protected.

8. The lightning protector as claimed in claim 7 further comprising a conductance connected to the point discharging device in series.

9. A lightning protector for a circuit having a load and two inputs, the lightning protector consisting essentially of:
a protection element adapted to connect to the load in parallel;
a capacitor connected to the protection element in parallel;
a conductance adapted to connect to one of inputs of the load in series; and
a point discharging device connected to the protection element in series and having two points spaced apart from each other for a predetermined distance such that when an input voltage is smaller than a critical voltage determined via the predetermined distance between the two points of the point discharging device, the protection element is inactivated and protected.
